(19) United States
(12) Patent Application Publication
(10) Pub. No.: US 2014/0142909 A1
(43) Pub. Date: May 22, 2014

(54) POWER SYSTEM STATE ESTIMATION METHOD BASED ON SET THEORETIC ESTIMATION MODEL

(71) Applicant: Tsinghua University, Beijing (CN)

(72) Inventors: Guangyu HE, Beijing (CN); Bin WANG, Beijing (CN); Qian CHEN, Beijing (CN); Kaicheng LIU, Beijing (CN); Wenxuan YANG, Beijing (CN)

(73) Assignee: Tsinghua University, Beijing (CN)

(21) Appl. No.: 14/076,561

(22) Filed: Nov. 11, 2013

(30) Foreign Application Priority Data
Nov. 16, 2012 (CN) 201210466339.1

(51) Int. Cl. G06F 17/50

(52) U.S. Cl. CPC G06F 17/5009
USPC 703/2

(57) ABSTRACT

A power system state estimation method based on set theoretic estimation model may be provided. In this method, all prior information of state estimation in a power system at least including a network topology and network parameters of the power system may be collected. A set theoretic estimation model for state estimation in the power system may be constructed by initializing original intervals of state variables and measurements and extending measurement constraints by algebraic manipulations to eliminate pessimism. Interval constraints propagation may be performed until the constraints to the state variables may be contracted. And resulting intervals of the state variables and measurements may be output.

### CROSS REFERENCE TO RELATED APPLICATIONS

This application claims priority and benefits of Chinese Patent Application No. 201210466339.1, filed with State Intellectual Property Office, P. R. C. on Nov. 16, 2012, the entire content of which is incorporated herein by reference.

### FIELD

Embodiments of the present disclosure generally relate to power area, more particularly, to a power system state estimation method based on a set theoretic estimation model.

### BACKGROUND

The following discussion of the background to the disclosure is intended to facilitate an understanding of the present disclosure only. It should be appreciated that the discussion is not an acknowledge or admission that any of the material referred to was published, known or part of the common general knowledge of the person skilled in the art in any jurisdiction as at the priority date of the disclosure.

State estimation for a power system utilizes redundancy available in a real-time measurement system to detect and eliminate incorrect data using estimation algorithms. And incorrect information caused by random disturbance may be automatically eliminated, thus data accuracy and consistency are improved. Using the estimation method to estimate the running status of the power system, it becomes the core and cornerstones for premium applications in the power system, and it also becomes an important component for modern Energy Management system (EMS).

There are various methods of state estimation proposed based on different estimation criterions since state estimation was initially established by Fred Charles Schweppe of MIT in 1970, such as WLS (weighted least square) criterion, non-quadratic criterion, WLAV (weighted least absolute value), quadratic-linear (QL) criterion and quadratic-constant (QC) criterion. In the existing methods as mentioned, a single solution is obtained by solving an optimal problem and the true state is claimed to be found. The objective function of the optimal problem is usually chosen based on some hypothesis for the statistical properties of measure errors. For example, the measure errors are assumed to be normally distributed in WLS estimation. Actually, these statistical properties are difficult to characterize in practice. Inexact matching of the assumed statistical hypotheses may lead to inaccurate estimates. That is, the credibility thereof may not be ensured.

In addition, due to the non-linear characteristics of the power system, the state estimation based on optimizing model may not be effectively solved, and the global optimization and convergence may not be ensured accordingly.

### SUMMARY

Embodiments of the present disclosure seek to solve at least one of the problems existing in the prior art to at least some extent, or to provide a user with a useful commercial choice.

Embodiment of the present disclosure may provide a power system state estimation method based on set theoretic estimation model. The power system state estimation method may comprise steps of: collecting all prior information of state estimation in a power system at least including a network topology and network parameters of the power system; constructing a set theoretic estimation model for state estimation in the power system by initializing original intervals of state variables and measurements and extending measurement constraints by algebraic manipulations to eliminate pessimism; performing interval constraints propagation until the constraints to the state variables are converged; and outputting resulting intervals of the state variables and measurements.

The above summary of the present disclosure is not intended to describe each disclosed embodiment or every implementation of the present disclosure. The Figures and the detailed description which follow more particularly exemplify illustrative embodiments.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference the accompanying drawings, in which:

FIG. 1 is a flow chart of a power system state estimation method based on a set-theory estimation model according to an embodiment of the present disclosure;

FIG. 2 is a detailed flow chart of a power system state estimation method based on a set-theory estimation model shown in FIG. 1;

FIG. 3 is a graph showing statistics regarding simulation results according to a conventional single-solution optimal method;

FIG. 4 is a graph showing average contract ratios of intervals of measurements in an IEEE 14-bus system according to a power system state estimation method based on a set-theory estimation model and a conventional optimal method; and

FIG. 5 is a graph showing average contract ratios of intervals of measurements in an IEEE 118-bus system according to a power system state estimation method based on a set-theory estimation model and a conventional optimal method.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

In addition, terms such as “first” and “second” are used herein for purposes of description and are not intended to indicate or imply relative importance or significance.

In the present disclosure, set theory estimation may be used for solving all acceptable solution consistent with measure data and a priori information rather than solving the optimal value or solution. In the set theory estimation, every information is described as a set in a solution space, which may be termed as an attribute set. And an intersection set of all the attribute sets is the feasible solution set. And the set theory application in the present disclosure may pay more attention to the feasibility rather than the optimization of the solution. In other words, known information may be utilized for obtaining more reliable solution set which is consistent with all utilizable information. The only method for restricting the feasible set resides in introducing more utilizable information during modeling.

A set-theory estimation model is constructed for power system state estimation. In a noise-bounded context, the model is degenerated into satisfying constraints. In the present disclosure, in combination with the characteristics of the power system, a solution based on interval constraint propagation is disclosed, with the obtained result interval being confidential, i.e., the true value being contained therein. In addition, the resulting interval has excellent interval contraction performance, and the state interval may be easily positioned. Further, the online application requirement may be satisfied for a large-scale system.

In the following, a power system state estimation method may be described in detail in combination with the accompanying figures. It has to be mentioned that, instead of a single solution, the set theoretic estimation systematically founded by P. L. Combettes in 1993 finds a set which encloses all acceptable solutions. Since the true state is also an acceptable solution, the set will be ensured to enclose the true state. That is to say, the true state is guaranteed to lie in the set. This guaranteed information is very important to the control systems basing on results of state estimation. And the set theoretic estimation focuses more on solution feasibility than solution optimization. The present disclosure constructs a novel set theoretic estimation model for state estimation in a power system by describing the prior information in a bounded error context which acceptable solutions have to be consistent with. Further, the present disclosure provides an algorithm based on interval analysis to solve the set theoretic estimation model and improves the algorithm according to the features of the power system to make it guaranteed, contraction efficient as well as time efficient.

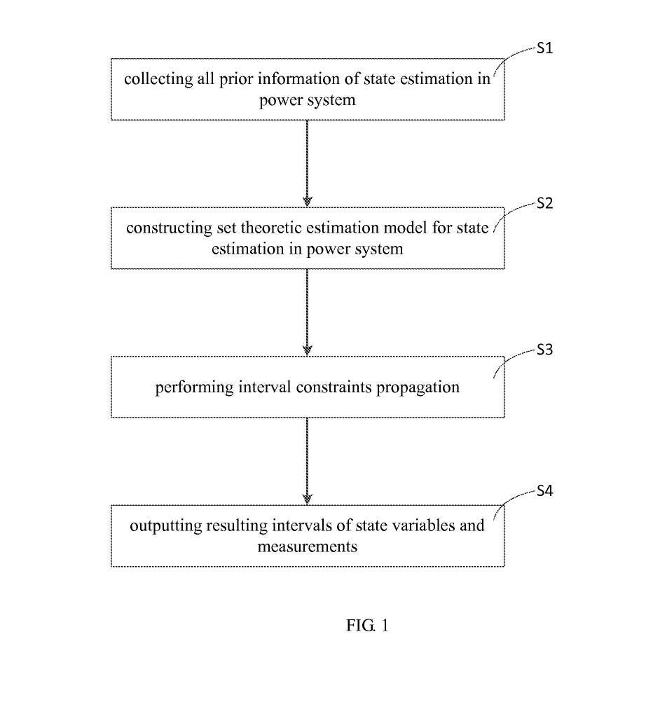

According to an embodiment of the present disclosure, a power system state estimation method based on set theoretic estimation model may be provided. FIG. 1 is a flow chart of the power system state estimation method based on a set-theory estimation model.

The power system state estimation method may comprise the following steps. S1: collecting all prior information of state estimation in a power system at least including a network topology and network parameters of the power system (S1); constructing a set theoretic estimation model for state estimation in the power system by initializing original intervals of state variables and measurements and extending measurement constraints by algebraic manipulations to eliminate pessimism (S2); performing interval constraints propagation until the constraints to the state variables are converged (S3); and outputting resulting intervals of the state variables and measurements (S4).

According to an embodiment of the present disclosure, the proposed method may utilize interval analysis and perform constraints propagation to obtain the contracted resulting intervals of the measurement and state variables, with the accuracy being guaranteed and contraction efficiency being improved dramatically based on monotonicity-based contractor and extended constraint set. In addition, the method is numerically fast since only simple interval arithmetic is involved, which is adaptive to large-scale power system.

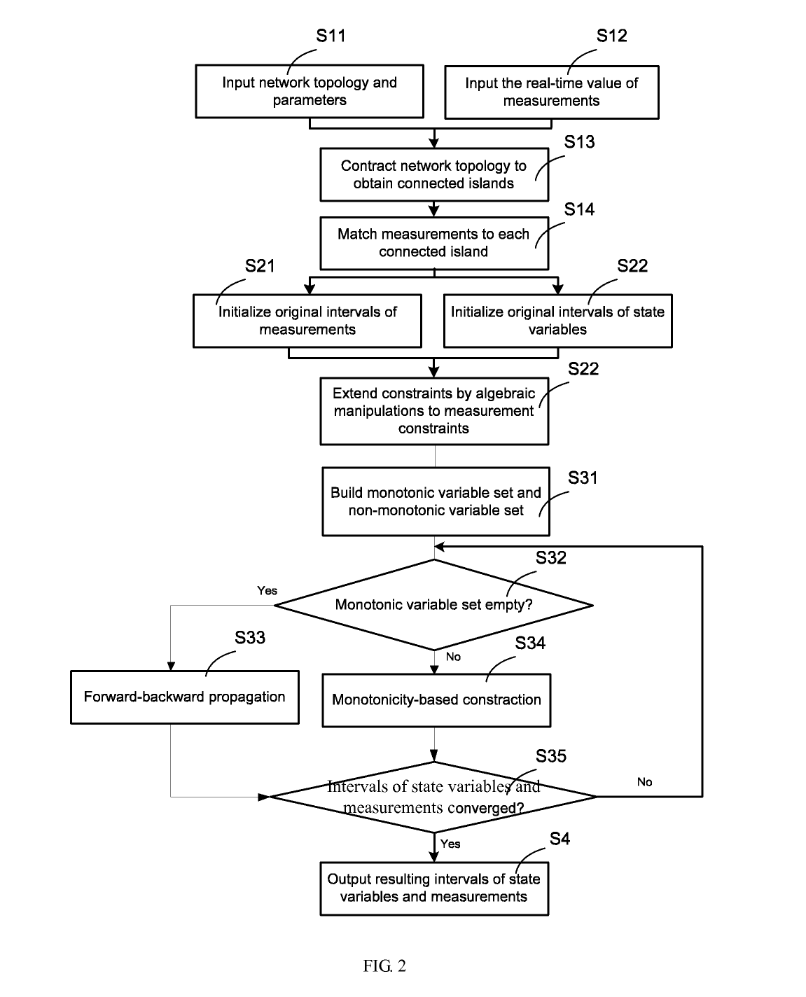

In the following, each of the steps mentioned above may be described in detail with reference to FIG. 2. FIG. 2 shows a detailed flow chart of a power system state estimation method based on a set-theory estimation model shown in FIG. 1.

Firstly, all prior information of state estimation in the power system may be collected (step S1). In one embodiment, the network topology and network parameters of the power system may be inputted (Step S11). In one embodiment, the network parameters may comprise series resistance, series reactance, parallel conductance and parallel susceptance of transmission lines in the power system, transformation ratio and resistance of a transformer in the power system, and resistances of capacitors and reactors connected in parallel between the transmission lines or buses. It has to be noted that above network parameters are exemplified for illustration purpose rather than limitation, any parameters in the power system may be aimed to be included herein. In one embodiment, the network topology may be composed of connecting relationship among generators, transmission lines, transformers, breakers, isolators, capacitors and reactors, buses and loads in the power system.

Real-time values of measurements in the power system, as well as the uncertainty interval of each measurement equipment in the power system may be inputted as measurement data (step S12). These measurement data may be prepared for constructing the set theoretic estimation model (explained in detail later). For example, voltages and powers at each bus node may be measured, and powers at ends of each transmission line, powers of windings at each transformer as well as switch measures of each breaker and isolator may be measured as well.

Then, the network topology may be contracted to obtain connected islands in the power system in which each have a plurality of nodes being connected by at least one branch (step S13). In one embodiment, the connected islands may be obtained by contracting the network topology with a depth-first search algorithm, as, for example, disclosed in “Depth-first search and linear graph algorithms”, Tarjan, Robert, Switching and Automata Theory, 1971., 12th Annual Symposium on, vol., no., pp. 114, 121, 13-15 Oct. 1971, which is herein incorporated by reference in its entirety. In one embodiment, All physical nodes connected with zero resistance within a substation island of the power system may be contracted into a topological node, and the transmission lines and transformers in the substation island may be equivalent as the branches, the capacitors and reactors in the substation island as grounded susceptances, so that the substation islands may be contracted into the connected topological islands.

Then, all the real-time measurement data from corresponding physical equipment of the power system may be matched to the corresponding nodes and branches in the connected islands (step S14). In one embodiment, the matched measurement data may be divided into five types, i.e. a voltage amplitude of a node i denoted as Vᵢ, an injection active power of the node i denoted as Pᵢ, an injection reactive power of a node i denoted as Qᵢ, a line active of a branch from a node i to a node j denoted as Pᵢⱼ, a line reactive of a branch from a node i to a node j denoted as Qᵢⱼ.

During the state estimation of the power system, the measurement equation may be expressed as z=h(x)+e, and the feasible solution set based on set theoretic estimation model may be expressed as S={x|z=h(x)+e,eεE}, where S is the solution set of set theoretic estimation, x is state variables of power system, z is measure vector, h is measure equations which correlate the state variables to the measurements, e is a measure error vector, E is a set of measure errors to be described in interval format.

In the power system, most measurements are very accurate, which means the measure errors are small and may be bounded. In the bounded-error context, the measure errors may be expressed as follows: eεE={e⁻≦e≦e⁺}, where e⁻ is a lower bound of the measure error while e⁺ is an upper bound of the measure error. Thus, the set theoretic estimation model may be described as follows: S={x|h(x)ε[z−e⁺, z+e⁻]}.

Then, the set theoretic estimation model for state estimation in the power system may be constructed accordingly (step S2). As shown in FIG. 2, original intervals of measurements)[y]⁽⁰⁾ may be initialized by [z−e⁺, z−e⁻] (step S21), where the upper and lower bounds of measure errors may be determined by uncertainty intervals of the measures of the measurement equipment in the power system, which may be provided as manufactured. That is to say, it is deemed that the interval of the measure error may be a confidence interval under certain confidence probability. Further, original intervals of state variables [x]⁽⁰⁾ may be initialized based on prior knowledge (step S22), such as [0.8, 1.2] for voltage amplitude, and [−π, π] for voltage angle etc.

When the process runs to step S23, the constraints may be extended by algebraic manipulations, such as add, subtraction, multiplication or division, to measurement constraints to eliminate the pessimism. In one embodiment, the measurement constraints may be extended by constraints of node power balance, branch power balance and angle difference respectively.

The constraint of node power balance means that node injection power and powers on all branches associated with the node as well as the grounded power are summed up as zero. In one embodiment, the constraints of the relationship between power injections and line power flow may be defined by the formula of:

$${P}_{i} = {\sum }_{j ∈ I} {P}_{ij} + {g}_{i}^{sh} {V}_{i}^{2}$$

$${Q}_{i} = {\sum }_{j ∈ I} {Q}_{ij} + {b}_{i}^{sh} {V}_{i}^{2}$$

where jεI and I denotes the set including all the nodes j that is connected with the node i by a line, gᵢ^{sh} and bᵢ^{sh} are the shunt conductance and susceptance of the node i respectively, Vᵢ denotes the voltage magnitude of the node I, Pᵢ denotes the injection active power of the node i, Qᵢ denotes an injection reactive power of the node I, Pᵢⱼ denotes a line active of a branch from the node i to the node j, and Qᵢⱼ denotes a line reactive of a branch from the node i to the node j.

In one embodiment, for the constraints of branch power balance, the constraints of the relationship between the start power flow and the end power flow of one branch may be constrained by the formula of

bᵢⱼ(Pᵢⱼ+Pⱼᵢ)+gᵢⱼ(Qᵢⱼ+Qⱼᵢ)=c₁Vᵢ²+c₂Vⱼ²

gᵢⱼ(Pᵢⱼ−Pⱼᵢ)−bᵢⱼ(Qᵢⱼ−Qⱼᵢ)=c₃Vᵢ²−c₄Vⱼ²

c₁=bᵢⱼgᵢⱼ^{sh}−gᵢⱼbᵢⱼ^{sh},c₂=bᵢⱼgⱼᵢ^{sh}−gᵢⱼbⱼᵢ^{sh},c₃=gᵢⱼ²+bᵢⱼ²+bᵢⱼbᵢⱼ^{sh},c₄=gᵢⱼ²+bᵢⱼ²+bᵢⱼbⱼᵢ^{sh},

where Vᵢ denotes a voltage magnitude of a node i, Vⱼ denotes a voltage magnitude of a node j, gᵢⱼ and bᵢⱼ are series conductance and susceptance of the branch from the node i to the node j respectively while gᵢⱼ^{sh} and bᵢⱼ^{sh} are parallel conductance and susceptance of the branch at the side of the node i, and gⱼᵢ^{sh} and bⱼᵢ^{sh} are parallel conductance and susceptance of the branch at the side of the node j, Pᵢⱼ denotes a line active of a branch from the node i to the node j, Pⱼᵢ denotes a line active of the branch from the node j to the node i, Qᵢⱼ denotes a line reactive of a branch from the node i to the node j, Qⱼᵢ denotes a line reactive of the branch from the node j to the node i.

In one embodiment, the constraints of the angle difference on a branch may be defined by the following formula:

θᵢⱼ=−θⱼᵢ

cos θᵢⱼ=cos θⱼᵢ

sin θᵢⱼ=sin θⱼᵢ

cos² θᵢⱼ+sin² θᵢⱼ=1

where θᵢⱼ is a voltage angle difference of branch from a node i to a node j, that is θᵢⱼ=θᵢ−θⱼ, while θᵢ is the voltage angle of the node i.

By the extending of the constraint sets as mentioned above, the accuracy of the resulting intervals of measures and state variables based thereupon may be improved dramatically.

In the following, the interval constraints propagation in step S3 may be described in detail. All constraints in the set theoretic estimation model may be defined by the formula of y=f(x), where [x] denotes the interval of the state variable and [y] denotes the interval of measurements in the power system. And k may denote the current iteration step which is initialized as zero. For each constraint i, the following steps below may be iterated until the terminal conditions is satisfied.

The interval of the state variables at the iteration step k may be denoted as [x]^{(k)}. And the monotonicity of constraints to the state variables is checked first, and a monotonic variable set v and a non-monotonic variable set w may be built for the constraints to the state variables (step S31). If vⱼεv is an increasing variable, then vⱼ is the lower bound of vⱼ and v̅ⱼ̅ is the upper bound of vⱼ. Then, it is determined whether the monotonic variable set v is empty or not (step S32). If the monotonic variable set v is empty, the forward-backward propagation is performed in the step S33. Otherwise, the mononicity-based contraction in step S34 may be performed instead. And the step S33 and S34 will be described in detail below.

In the step S33, for each constraint i, the interval of measurement [yᵢ] may be contracted with [yᵢ]^{(k+1)}=[yᵢ]^{(k)}∩fᵢ([x]^{(k)}) in forward propagation, and the interval of the state variables [x] may be contracted with [x]^{(k+1)}=[x]^{(k)}∩fᵢ⁻¹([y]^{(k+1)}) in the backward propagation. Then step S35 is executed.

In the step S34, if the monotonic variable set v is not empty, the interval of the non-monotonic variable set [w] and the interval of the monotonic variable set [v] may be contracted based on monotonicity respectively. In one embodiment, it is defined that f_{i,min}(w)=fᵢ(v, w) and f_{i,max}(w)=fᵢ( v̅, w), and [yᵢ] and [w] may be contracted with the constraints of f_{i,min}(w)≦yᵢ and f_{i,max} (w)≧yᵢ in the forward propagation and the backward propagation respectively. Without loss of generality, considering an increasing variable vⱼεv, the left variables in v may be denoted as v_{left}^{j}, the equation (1) may be solved to obtain the new upper bound vⱼ⁺ and the equation (2) may be solved to obtain the new lower bound vⱼ⁻.

[ f̅ᵢ̅(̅v̅_̅{̅l̅e̅f̅t̅}̅^̅{̅j̅}̅,̅[̅w̅]̅^̅{̅(̅k̅)̅}̅)̅]̅= [̅y̅ᵢ̅]̅^̅{̅(̅k̅)̅}̅ (1)

[̅f̅ᵢ̅(̅v̅_̅{̅l̅e̅f̅t̅}̅^̅{̅j̅}̅,̅[̅w̅]̅^̅{̅(̅k̅)̅}̅)̅]̅= [̅y̅ᵢ̅]̅^̅{̅(̅k̅)̅}̅ (2)

Then the interval of the monotonic variable set [v] may be contracted with [vⱼ]^{(k+1)}=[vⱼ⁻, vⱼ⁺]∩[vⱼ]^{(k)}. And the interval of the non-monotonic variable set [w] and the interval of the monotonic variable set [v] may be combined to form a new set of interval of state variables [x]^{(k+1)}=([v]^{(k+1)}, [w]^{(k+1)}).

In step S35, if the intervals of the state variables and measurement are converged at the iterating step (k+1), the iteration of the steps S31-S34 is terminated. In other words, if the distance between [x]^{(k+1)} and [x]^{(k)} and the distance between [y]^{(k+1)} and [y]^{(k)} may be both smaller than a predetermined threshold ε, the iteration ends and the final result intervals of both state variables and measures are obtained accordingly, otherwise the iteration may continue. In one embodiment, the predetermined threshold ε may be 1×10⁻⁵.

Lastly, the resulting converged intervals of the state variables and measurements may be outputted accordingly in step S4.

According to the power system state estimation method of the present disclosure, interval analysis and constraints propagation may be utilized to solve the set theoretic estimation model for state variables and measure estimation in power system, with the contraction efficiency being ensured by monotonicity-based contractor and the extended constraints set as discussed above. In addition, the credibility of the resulting intervals of the state variables and measures may be improved, with data calculation being reduced to a large extent. Further, the procedure is very fast since there is only simple interval arithmetic being involved, which may be well adaptive in a large-scale power system.

To further demonstrate the performance of the power system state estimation method of the present disclosure, numerical simulation may be calculated for comparing the proposed method and the conventional optimal method.

### Example

The numerical results of the proposed method and a conventional single-solution optimal method as disclosed in “Uncertainty modeling in power system state estimation” by A. K. Al-Othman and M. R. Irving, IEE Proc.—Gener. Transm. Distrib., vol. 152, pp. 233-239, March. 2005 which is herein incorporated for reference in its entirety, may be compared with each other using three different strategies. The first strategy relates to a true-value guarantee test to determine whether the true values always lie in the resulting intervals of the state variables and measures. The second strategy relates to the contraction efficiency test to determine whether the result intervals are narrow enough. And the third strategy relates to a time efficiency test to determine whether the method is adapted in a real-time context. In all the tests, measurements are placed on every bus and branch, and the measurement error is represented as a uniform distribution over the interval [−2%, 2%] of the nominal value Zₜ of the measurements. In the initial step, the measurements are set to be [0.98zₜ, 1.02zₜ] to guarantee that the true values lie in the initial interval.

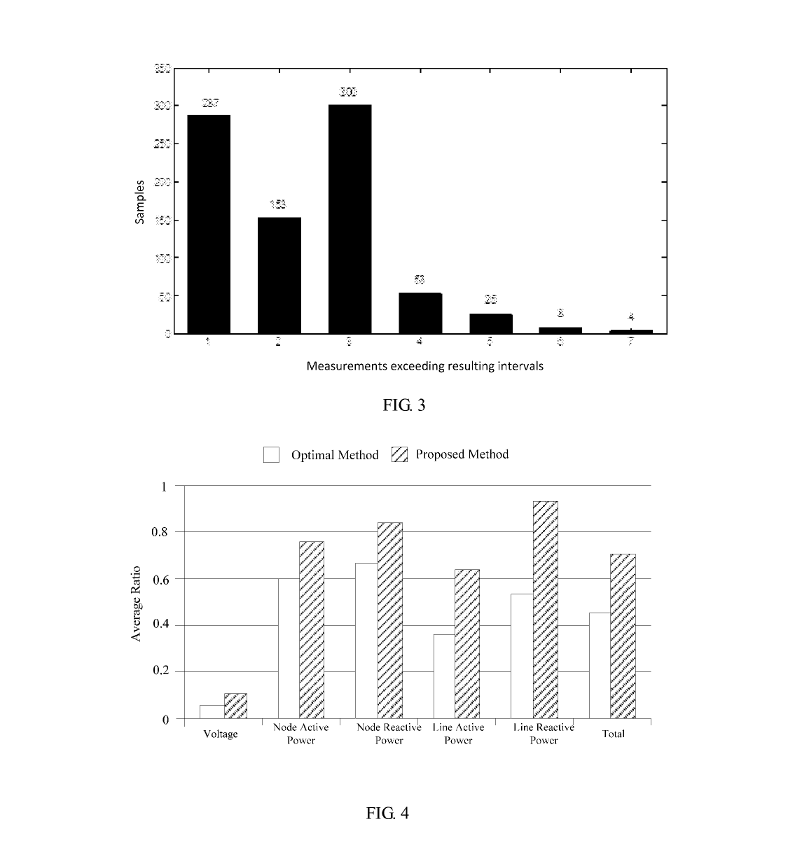

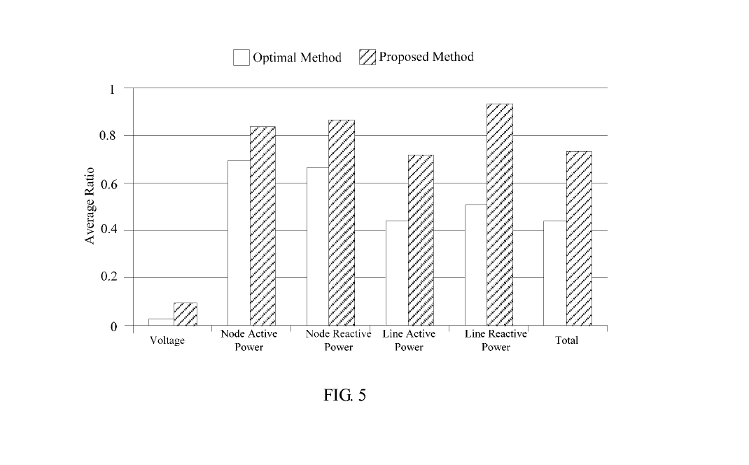

Firstly, 2000 samples on the IEEE 14-bus system are simulated by adding uniformly distributed errors to the true values of measures. All results in the proposed method are guaranteed whereas there are state variables exceeding the result intervals by 3 samples and measurements exceeding the result intervals by 830 samples in the optimal method. FIG. 3 shows the statistical results of the number of measures which may exceed the result intervals in the samples.

In addition, Table 1 shows the result intervals of states in one of the samples. The underlined true value of the voltage on bus 9 exceeds the result interval according to the optimal method, while all result intervals of states from the proposed method are guaranteed.

TABLE 1
Comparative Result Intervals of States

| | | Proposed Method | | Optimal Method | | | Proposed Method | | Optimal Method | |
|---|---|---|---|---|---|---|---|---|---|---|
| Bus | Voltage | Lower | Upper | Lower | Upper | Angle | Lower | Upper | Lower | Upper |
| 1 | 1.06 | 1.05725 | 1.06307 | 1.05731 | 1.06017 | 0.0000 | 0.0000 | 0.0000 | 0.0000 | 0.0000 |
| 2 | 1.045 | 1.04209 | 1.04816 | 1.04237 | 1.04511 | −0.0869 | −0.0878 | −0.0860 | −0.0875 | −0.0867 |
| 3 | 1.01 | 1.00673 | 1.01288 | 1.00713 | 1.01020 | −0.2220 | −0.2256 | −0.2198 | −0.2237 | −0.2214 |
| 4 | 1.019 | 1.01630 | 1.02160 | 1.01642 | 1.01910 | −0.1803 | −0.1833 | −0.1786 | −0.1815 | −0.1798 |
| 5 | 1.02 | 1.01740 | 1.02269 | 1.01743 | 1.02009 | −0.1532 | −0.1559 | −0.1520 | −0.1543 | −0.1530 |
| 6 | 1.07 | 1.06631 | 1.07028 | 1.06720 | 1.07006 | −0.2482 | −0.2540 | −0.2447 | −0.2502 | −0.2472 |
| 7 | 1.062 | 1.05870 | 1.06204 | 1.05931 | 1.06200 | −0.2334 | −0.2380 | −0.2307 | −0.2350 | −0.2325 |
| 8 | 1.09 | 1.08657 | 1.09053 | 1.08730 | 1.09027 | −0.2332 | −0.2378 | −0.2305 | −0.2349 | −0.2324 |
| 9 | 1.056 | 1.05264 | 1.05601 | 1.05329 | 1.05598 | −0.2608 | −0.2662 | −0.2578 | −0.2628 | −0.2596 |
| 10 | 1.051 | 1.04756 | 1.05109 | 1.04827 | 1.05103 | −0.2635 | −0.2691 | −0.2605 | −0.2656 | −0.2625 |
| 11 | 1.057 | 1.05348 | 1.05718 | 1.05424 | 1.05706 | −0.2581 | −0.2638 | −0.2549 | −0.2602 | −0.2571 |
| 12 | 1.055 | 1.05107 | 1.05546 | 1.05219 | 1.05516 | −0.2630 | −0.2691 | −0.2594 | −0.2652 | −0.2618 |
| 13 | 1.05 | 1.04608 | 1.05031 | 1.04713 | 1.05010 | −0.2646 | −0.2707 | −0.2611 | −0.2668 | −0.2634 |
| 14 | 1.036 | 1.03206 | 1.03612 | 1.03302 | 1.03601 | −0.2800 | −0.2862 | −0.2768 | −0.2824 | −0.2788 |

Table 2 shows the average width of the result intervals of states obtained by the two methods mentioned above. FIGS. 3 and 4 present the average ratios between the widths of the result intervals and those of the prior intervals of measurements. In the juxtaposed bars in the FIGS. 3 and 4, measurements are classified into five types, which are voltage, bus active power, bus reactive power, line active power and line reactive power respectively. Columns labeled “Total” shows average ratios of all measurements.

TABLE 2
Average Width for Intervals of States

| | |
|---|---|
| Voltage | Angle |

| | Optimal | Proposed | Optimal | Proposed |
|---|---|---|---|---|
| Power System | Method | Method | Method | Method |
| IEEE 14 | 0.0028 | 0.0045 | 0.1497 | 0.4164 |
| IEEE 118 | 0.0009 | 0.0028 | 0.1307 | 0.4013 |

Although the result intervals based on the proposed method are not the smallest due to local consistency, they are already small enough to be used in the real-time closed-loop control system. Taking voltages for example, the control dead zone for voltages in some automatic voltage control systems (AVC) is 0.5% of the nominal value. The average widths of voltage intervals based on the proposed method is 0.45%, which is smaller than the control dead zone. Since the resulting intervals are guaranteed, the resulting intervals are accurate the same as the true values to the control system.

Table 3 shows the computation time of the optimal method as well as the proposed method in different power systems. The computation time of the optimal method increases rapidly when the dimension of calculation increases, whereas the proposed method is much faster. Therefore, the proposed method is more amicable for a large-scale power system.

TABLE 3
Computation Time Comparison

| | Measurement | Proposed | Optimal Method/s | |
|---|---|---|---|---|
| System | Number | Method/s | States | Measurements |
| IEEE 3 | 17 | 0.043 | 0.163 | 0.269 |
| IEEE 14 | 110 | 0.197 | 1.480 | 4.002 |
| IEEE 30 | 229 | 0.319 | 5.010 | 13.799 |
| IEEE 118 | 1054 | 1.799 | 89.977 | 311.398 |
| IEEE 300 | 2091 | 4.647 | 466.401 | 1183.402 |

Although explanatory embodiments have been shown and described, it would be appreciated by those skilled in the art that the above embodiments can not be construed to limit the present disclosure, and changes, alternatives, and modifications can be made in the embodiments without departing from spirit, principles and scope of the present disclosure.

What is claimed is:

1. A power system state estimation method based on set theoretic estimation model, comprising steps of:
S1: collecting all prior information of state estimation in a power system at least including a network topology and network parameters of the power system;
S2: constructing a set theoretic estimation model for state estimation in the power system by initializing original intervals of state variables and measurements and extending measurement constraints by algebraic manipulations to eliminate pessimism;
S3: performing interval constraints propagation until the constraints to the state variables are converged; and
S4: outputting resulting intervals of the state variables and measurements.

2. The power system state estimation method of claim 1, wherein the step S1 further comprises steps of:
S11: inputting the network topology and the network parameters of the power system;
S12: inputting real-time values of measurements in the power system, as well as uncertainty intervals of measurements of measurement equipment in the power system as measurement data;
S13: contracting the network topology to obtain connected islands in the power system in which each have a plurality of nodes being connected by at least one the branch; and
S14: matching all measure data to nodes and branches of the islands.

3. The power system state estimation method of claim 2, wherein the connected islands are obtained by contracting the network topology with depth-first search algorithm.

4. The power system state estimation method of claim 2, wherein the network parameters comprises series resistance, series reactance, parallel conductance and parallel susceptance of transmission lines in the power system, transformation ratio and resistance of a transformer in the power system, and resistances of capacitors and reactors connected in parallel between the transmission lines or buses.

5. The power system state estimation method of claim 2, wherein the network topology is composed of connecting relationship among generators, transmission lines, transformers, breakers, isolators, capacitors and reactors, buses and loads in the power system.

6. The power system state estimation method of claim 1, wherein the step S2 further comprises steps of:
S21: initializing the original intervals of measurements;
S22: initializing the original intervals of state variables according to prior knowledge; and
S23: extending measurement constraints by algebraic manipulations to eliminate pessimism.

7. The power system state estimation method of claim 6, wherein the measurement constraints are extended by constraints of node power balance, branch power balance and angle difference respectively in the step S23.

8. The power system state estimation method of claim 7, wherein the constraints of the node power balance are defined by the formula of:
$${P}_{i} = {\sum }_{j ∈ I} {P}_{ij} + {g}_{i}^{sh} {V}_{i}^{2}$$
$${Q}_{i} = {\sum }_{j ∈ I} {Q}_{ij} + {b}_{i}^{sh} {V}_{i}^{2}$$
where I denotes the set including all nodes j that are connected with the node i by a line respectively, gᵢ^{sh} and bᵢ^{sh} are the shunt conductance and susceptance of the node i respectively, Vᵢ denotes the voltage magnitude of the node i, Pᵢ denotes the injection active power of the node i, Qᵢ denotes an injection reactive power of the node I, Pᵢⱼ denotes a line active of a branch from the node i to the node j, and Qᵢⱼ denotes a line reactive of a branch from the node i to the node j.

9. The power system state estimation method of claim 7, wherein for the constraints of branch power balance, the constraints of the relationship between the start power flow and the end power flow of a branch are defined by the formula of:
bᵢⱼ(Pᵢⱼ+Pⱼᵢ)+gᵢⱼ(Qᵢⱼ+Qⱼᵢ)=c₁Vᵢ²+c₂Vⱼ²
gᵢⱼ(Pᵢⱼ−Pⱼᵢ)−bᵢⱼ(Qᵢⱼ−Qⱼᵢ)=c₃Vᵢ²−c₄Vⱼ²
c₁=bᵢⱼgᵢⱼ^{sh}−gᵢⱼbᵢⱼ^{sh},c₂=bᵢⱼgⱼᵢ^{sh}−gᵢⱼbⱼᵢ^{sh},c₃=gᵢⱼ²+bᵢⱼ²+bᵢⱼbᵢⱼ^{sh},c₄=gᵢⱼ²+bᵢⱼ²+bᵢⱼbⱼᵢ^{sh},
where Vᵢ denotes a voltage magnitude of a node i, Vⱼ denotes a voltage magnitude of a node j, gᵢⱼ and bᵢⱼ are series conductance and susceptance of the branch from the node i to the node j respectively while gᵢⱼ^{sh} and bᵢⱼ^{sh} are parallel conductance and susceptance of the branch at the side of the node i, and gⱼᵢ^{sh} and bⱼᵢ^{sh} are parallel conductance and susceptance of the branch at the side of the node j, Pᵢⱼ denotes a line active of a branch from the node i to the node j, Pⱼᵢ, denotes a line active of the branch from the node j to the node i, Qᵢⱼ denotes a line reactive of a branch from the node i to the node j, Qⱼᵢ denotes a line reactive of the branch from the node j to the node i.

10. The power system state estimation method of claim 7, wherein the constraints of the relationship of angle difference on a branch are defined by the formula of:
θᵢⱼ=−θⱼᵢ
cos θᵢⱼ=cos θⱼᵢ
sin θᵢⱼ=sin θⱼᵢ
cos² θᵢⱼ+sin² θᵢⱼ=1
where θᵢⱼ is a voltage angle difference of the branch from a node i to a node j while θᵢ is a voltage angle of the node i.

11. The power system state estimation method of claim 1, wherein the step S3 further comprises steps of:
S31: building a monotonic variable set v and a non-monotonic variable set w for the constraints to the state variables;
S32: determining whether the monotonic variable set v is empty or not;
S33: if the monotonic variable set v is empty, contracting the intervals of state and measurement using forward-backward propagations respectively;
S34: if the monotonic variable set v is not empty, contracting the monotonic variable set v and the non-monotonic variable set w based on monotonicity in the forward and backward propagations respectively; and
S35: iterating steps S31-S34 until the intervals of the state variables and measurement are converged.

12. The power system state estimation method of claim 11, wherein in step S33, for each constraint i, [yᵢ] is contracted with [yᵢ]^{(k+1)}=[yᵢ]^{(k)}∩fᵢ([x]^{(k)}) in a forward propagation step, and [x] is contracted with [x]^{(k+1)}=[x]^{(k)}∩fᵢ([y]^{(k+1)}) in a backward propagation step, where
all constraints to the state variables are defined by the formula of y=f (x), where [x] denotes an interval to the state variables and [y] denotes an interval of measurements in the power system.

13. The power system state estimation method of claim 12, wherein in the step S34, [yᵢ] and [w] are constructed with constraints of f_{i,min}(w)≦yᵢ and f_{i,max}(w)≧yᵢ in the forward propagation and the backward propagation respectively, where f_{i,min}(w)=fᵢ(v, w) and f_{i,max} (w)=fᵢ( v̅, w), and v denotes a lower bound of the monotonic variable set v, and v̅ denotes an upper bound of the monotonic variable set v.
